(19) United States
(12) Patent Application Publication
(10) Pub. No.: US 2003/0046339 A1
(43) Pub. Date: Mar. 6, 2003

(54) System and method for determining location and status of computer system server

(76) Inventor: Johnny Chong Ching Ip, Leander, TX (US)

Correspondence Address: Khannan Suntharam, Baker Botts L.L.P., One Shell Plaza, 910 Louisiana Street, Houston, TX, 77002-4995, US

(21) Appl. No.: 09/946,442

(22) Filed: Sep. 5, 2001

(51) Int. Cl. G06F 15/16

(52) U.S. Cl. 709/203

(57) ABSTRACT

A system and method for collecting and displaying status information is disclosed. A group of servers is associated with a data collection unit that collects status and location information from sensors located in the servers and server racks. The data collection unit includes a communication circuit in order to allow one or more users to obtain the status and location information of the servers over a network.

### TECHNICAL FIELD

The present disclosure relates in general to the field of computer systems, and, more particularly, to a system and method for displaying status and location information.

### BACKGROUND

A data center, also referred to as a server farm, typically includes a group of networked servers. The networked servers are housed together in a single location. A data center expedites computer network processing by combining the power of multiple servers and allows for load balancing by distributing the workload among the servers. More companies and other organizations are using data centers because of the efficiency of these centers in handling vast numbers of storage retrieval and data processing transactions. Depending on the nature and size of the operation, a data center may have thousands of servers. As various industries move toward smaller servers, web farms, redundant servers and distributed processing, data centers will continue to grow. The servers of the data center may each serve different functions. For example, a data center may have web, database, application, file or storage, or network related servers, among other types.

Typically, these servers are rack-mounted and placed in cabinets or racks. Each rack may hold dozens of rack-mounted servers. These racks are generally organized into banks or aisles. Accordingly, a large data center may have several banks of racks that each contain several rack-mounted servers. All of these servers within the data center are typically monitored via a single console by one or two individuals who serve as network monitors.

Because data centers are often implemented in mission critical operations that demand continuous and reliable operation, the servers of these data centers must operate continuously with very few failures. In the event of a server failure, the problem must be solved immediately. In this sort of environment, any down time is unacceptable. For example, if the data center of a financial firm goes down, a minute of down time can result in thousands of dollars of revenue in unexecuted stock transactions. Often, a failed or failing server component is the cause of the server failure. Examples of server components that may fail include fans, hard drives, motherboards, PCI cards, memory DIMMs, power supplies, cables, and CPUs, among other components. In the event of a system failure, the network monitors must dispatch a technician to the data center to find and replace the faulty component. Because the data center is used for a continuous or mission critical function, the technician must replace the faulty component as soon as possible. Accordingly, it is important for technicians to know the locations, e.g. which shelf, bank or cabinet contains the server, and the general conditions, e.g. power supply status, temperature, whether cabinet doors are open or closed, of the servers in order to monitor and service the servers. In the event of a service outage, a technician must have information regarding the location and condition of the server in order to quickly resolve the problem.

Because a data center may have servers relating to a wide variety of functions, a diverse group of technicians may need to have access to the servers in the data center. For example, technicians involved with software development, quality assurance, system testing, and operations, among other departments, may need to determine the condition of servers within the data center. As a result, it is not uncommon for technicians responding to a service outage to be unfamiliar with the layout of the data center. Furthermore, given the large number of servers within a data center, the technicians may have difficulty locating a specific server to ascertain its condition. The difficulty of locating a particular server is exacerbated by the frequency with which servers are installed, moved, torn down, rebuilt or reinstalled.

Conventional data centers typically use server management software to monitor server components and alert system monitors in the event of a component failure. For example, if one of the hard drives of a server fails, then the server management software will send an alert message to the system monitor's console. The network monitor will respond to the alert message and rectify the failure. Examples of server management software include ping, NetIQ, Performance Monitor, Windows Monitoring Interface, heartbeat, Simple Network Management Protocol (SNMP) applications, and NetLog, among other examples. Server management software typically collect information from server condition sensors are located within the servers to determine the status of the servers. For example, these sensors may measure air temperature inside the server, monitor the functioning of fans and power supplies, or perform other monitoring or measuring functions. The measurement or monitoring data is generally communicated to users via the software running on the server and the network connection within the server. This software is dependent on the operating system platform and on the proper functioning of the server. Accordingly, if the operating system crashes or is incompatible with the server management software, the status data may not be sent to the user. This problem is exacerbated by the increasing complexity and diversity of the software that is installed across the various servers in the data center.

### SUMMARY

In accordance with teachings of the present disclosure, a system and method for displaying status information from several devices in a computer system is disclosed that provides significant advantages over prior developed systems.

A data collection unit is associated with a rack or a group of servers. The data collection unit comprises a data collection circuit that is operable to collect data from the server sensors and rack sensors of the devices associated with the data collection unit. Each server and rack may be associated with a unique address or identification number. The data collection circuit may also collect this location information. The data collection unit also comprises a communication circuit. Accordingly, the data collection unit may be connected to a computer network. Users on the network may query the data collection unit via the communication circuit and obtain status and location information for the servers.

A technical advantage of the present disclosure is that multiple users may access status and location information for a data center. These users may access the status and location information from the data collection units over a network. The use of the data collection circuits allows technicians to locate servers without manually maintaining records of the physical locations of the servers. Because multiple users may monitor the status and location of the servers, technicians are in a better position to respond to and to resolve service outages.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a logical view of a data center and network;

FIG. 2 is a conceptual block diagram of the information processing of the data center and network;

FIG. 3 is an pictorial view of a data center;

FIG. 3b is a pictorial view of a server rack and data collection unit;

FIG. 4a and 4b are exemplary depictions of the tables associated with the data collection unit

FIGS. 5a and 5b are exemplary depictions of the tables associated with the secondary data collection program;

FIG. 6 is a conceptual block diagram of a rack and data collection unit; and

FIG. 7 conceptual block diagram of a load bearer, servers and data collection unit.

### DETAILED DESCRIPTION

The present detailed description discloses a system and method for locating a server in a data center and determining the status of the server. The present disclosure allows multiple users to locate and monitor any server in a data center. In one embodiment, the users may monitor the servers from a centralized location. In another embodiment, the users may access or obtain the status history for any server in the data center.

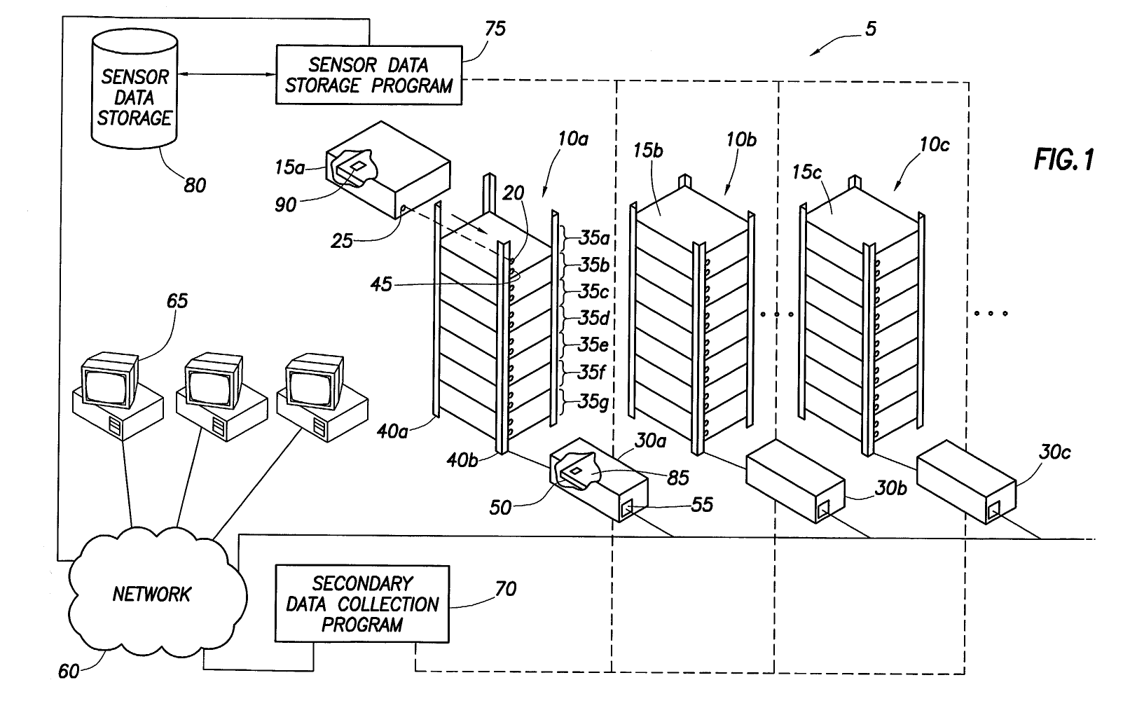

FIG. 1 shows a data center, indicated generally at 5. Data center 5 contains one or more cabinets or racks 10. Each rack 10 is designed to hold one or more servers 15. For example, each rack 10 may have four posts 40: two in the front and two in the back. These posts 40 may define several slots 35 to receive servers 15. Each post 40 may have mounting holes that interconnect with mounting fasteners to fix the vertical position of the server 10 when the server is inserted into the rack 10. Rack 10 may employ any other mechanical device to contain or support servers 15. Racks 10 may contain other components such as cabinet doors, one or more power supplies, and fans, among other devices.

Each rack 10 may also contain one more rack sensors 45 that may collect rack-wide sensor data. Generally, rack sensors 45 collect data that is common to all of the servers 15 on the rack 10. For example, rack sensors 45 collect data including, but not limited to, line voltage quality, rack fan performance, and whether the rack cabinet doors are open or closed, among other rack level data. The number and type of rack sensors 45 may vary depending on redundancy or monitoring requirements. One or more rack connectors 20 are mounted on rack 20. For example, rack connector 20 may be mounted on one of the rear posts 40b of rack 20. Each rack connector 20 is mounted to correspond to a location on rack 10 suitable to contain a server 10. For example, in the embodiment shown in FIG. 1, rack connector 20c corresponds to the third slot 35c of rack 10.

Each server 15 contains a server connector 25 that couples to a rack connector 20 when the server is inserted or mounted into rack 10. Preferably, server 15 may not be inserted into rack 10 without causing a rack connector 20 to couple with server connector 25. The coupling of rack connector 20 and server connector 25 creates a communicative or electrical coupling. The connection between rack connector 20 and server connector 25 may be a direct electrical coupling, RF coupling, IR coupling, or any other coupling suitable to transmit information. For instance, rack connector 20 and server connector 25 may be a pair of electrical contacts that couple when server 15 is fully seated in rack 10. Rack connector 20 and server connector 25 may also mechanically couple. The type of connection between the rack connector 20 and server connector 25 depends on the type of communication protocol used by server 15. For example, the connection may be a serial connection, or other type of network protocol connection, such as Ethernet, for example.

Each server 15 also preferably contains one or more server sensors 90. As discussed above, server sensors 90 monitor the conditions of the server. For example, server sensors 90 may monitor temperature conditions, power supply status, whether specific components are malfunctioning, whether the server has been turned on, whether the server housing is open or closed, and other server level measurement or monitoring functions.

A data collection unit 30 is preferably associated with each rack 10 or is otherwise associated with a group of servers 15. The data collection unit 30 may be mounted on rack 10. The coupling of rack connector 20 and server connector 25 allows information to be transmitted to data collection unit 30. For example, the location of the server 15 within rack 10 may be communicated to data collection unit 30. Each server 15 is associated with a unique server identification number or code. For example, a server 15 may be identified by a MAC address or an IP address. Each rack 10 is also associated with a unique rack identification number or code. For example, a dip switch may be associated with each rack 10 such that each rack 10 may be identified by a binary number or code defined by that dip switch. Alternatively, rack 10 may be identified by the identification number or code corresponding to the data collection unit 30 associated with that rack 10. Similarly, each rack connector 20 is associated with a specific location within rack 10 and may be associated with a unique rack connector identification number or code. Accordingly, when rack connector 20 and server connector 25 are coupled, information identifying server 15 and its location in rack 10 may be sent to data collection unit 30. For example, when server 15a is inserted into slot 35b of rack 10a, server connector 25a couples with rack connector 20b. Accordingly, the location information, i.e. that server 15a is in the second slot 35b of rack 10a, is sent to data collection unit 30a.

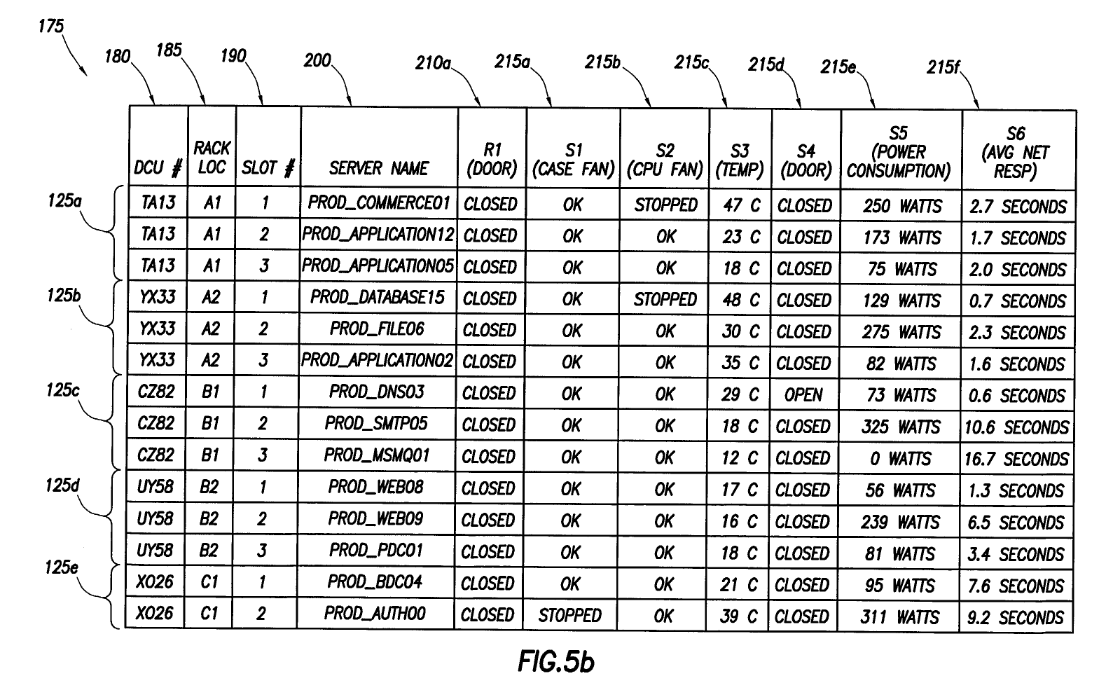

Data collection unit 30 may also receive data or information from other sources in order to determine the location of server 15. FIG. 6 depicts an alternate embodiment of the present disclosure and shows block diagram of a rack 10, servers 15 and data collection unit 30. An radio frequency identification (RFID) tag 320 may be associated with rack 10. Rack RFID tags 320 may contain data regarding the unique identification of rack 10, among other information relating to rack 10. Similarly, RFID tags 325 may be associated with servers 15. Server RFID tag 325 may contain data regarding the unique identification of server 15, among other information relating to server 15. As discussed below, data collection unit 30 contains a data collection circuit 85. The data collection circuit 85 may include a reader or interrogator to collect data from the RFID tags 320 and 325. Accordingly, data collection unit 30 may identify the rack 10 and the servers located in rack 10 by reading the RFID tags 320 and 325. Furthermore, data collection unit 30 may determine the position of server 15 within rack 10 based on the signal strength of the server RFID tags 325. In addition, data collection unit 30 may collect rack or server status information from the RFID tags 320 and 325. For example, RFID tags 320 and 325 can be used to monitor the power to and from server 15. For instance, RFID tags 320 and 325 may receive power from server 15 or rack 10. The tags 320 and 325 will have power to respond to an interrogation signal from data collection unit 30 as long as server 15 and rack 10 receive an adequate power supply. Accordingly, if data collection unit 30 does not receive information from either RFID tags 320 or 325, then this may indicate a problem with server 15 or rack 10.

Data collection unit 30 may also receive status information from the servers 15 that are associated with the data collection unit 30. The coupling of rack connector 20 and server connector 25 allows status information to be transmitted from the server sensors 90 to data collection unit 30. For example, a serial communication circuit may send serial signals from the server sensor circuits 90 within the server 15 to the data collection unit 30. Accordingly, data collection unit 30 may receive the measurement and monitoring data collected from the server sensors 90 of the associated servers 15. Data collection unit 30 may also collect the measurement and monitoring data collected from the rack sensors 45.

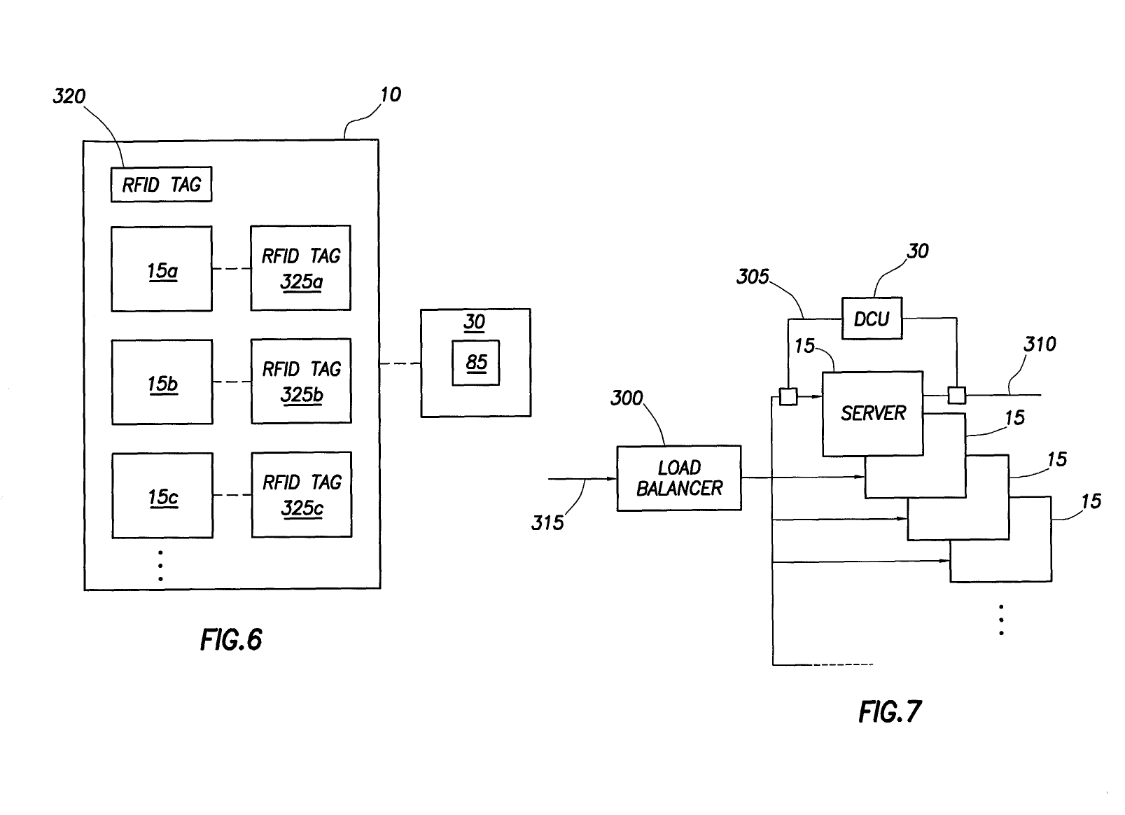

Data collection unit 30 may also receive data or information from other sources in order to determine the status of server 15. FIG. 7 depicts an alternate embodiment of the present disclosure and shows a block diagram of a load balancer 300 and a group of servers 15. Load balancer 300 may be a server, router, firewall or any other similar device or combination of hardware and software that performs load balancing functions for a group of servers. Load balancer 300 receives the network request signals 315 and divides them into separate request signals 305 that may be distributed to individual servers 15. Load balancer 300 distributes the request signals 305 between its associated servers 15 based on the capacity of each server 15 to handle additional requests. After processing the request signal 305, server 15 produces a response signal 310. Data collection unit 30 may receive both the request signal 305 and the response signal 310. Accordingly, data collection unit 30 may determine the status of server 15 based on these two signals 305 and 310. For example, the data collection unit 30 may determine whether server 15 is heavily loaded. For instance, data collection unit 30 may determine that server 15 is taking longer than expected to respond to request signal 305. Data collection unit 30 may determine that server 15 has crashed because it has not produced a response signal 310 within a predetermined period of time. In response to determining that server 15 is excessively loaded or has crashed, data collection unit 30 may send a warning signal to load balancer 300, automatically reboot the affected server 15, notify a user, or any other appropriate action.

Sensor data from the rack sensors 45 and the server sensors 90 is preferably directly transmitted to the data collection unit 10 rather than via software running on the server 15. As the server 15 is inserted into the rack 10, the connection of the sensor and rack connectors 25 and 20 provide a parallel path for the sensor data that bypasses the operating system. Accordingly, the transmission of sensor data may be independent of the proper functioning of the operating system and the data collection software running on that operating system. Thus, in the event of a software malfunction, sensor data may still be sent to data collection unit 30. Furthermore, the data collecting functionality of data collection unit 30 is not affected by the use of different brands and versions of operating systems and data collection software across the various servers 15 in the data center 10. Accordingly, the data collection unit 30 does not need to be upgraded as the server software is updated or changed.

Data collection unit 30 also contains data collection circuit 85 and network port 55. Data collection circuit 85 collects and processes the data transmitted to data collection unit 30. Data collection circuit 85 may be any combination of software and hardware suitable for collecting, processing and transmitting data. Data collection circuit 85 includes or is communicatively connected to a communication circuit 50. A communication circuit 50 is any combination of hardware or software operable to communicate and receive signals according to at least one network protocol. For example, network protocols suitable for communication circuit 50 include, but not limited to, hypertext transfer protocol (HTTP), simple mail transfer protocol (SMTP), transmission control protocol/Internet protocol (TCP/IP), Internet protocol (IP), address resolution protocol (ARP), Internet relay chat (IRC), user datagram protocol (UDP), transmission control protocol (TCP), IP Multicasting, Internet group management protocol (IGMP), and Internet control message protocol (ICMP), among other examples.

Communication circuit 50 is preferably a web server circuit. A web server circuit is essentially a web server that is implemented as a single microcontroller or programmable interrupt controller (PIC). A web server circuit may include a central processing unit (CPU), memory, serial port interface circuitry, a clock oscillator, among other components. The memory of the web server circuit may contain the code necessary to implement the web server circuit as a TCP/IP stack, for example. Because the web server circuit may support HTTP, hypertext markup language (HTML), and similar web protocols, a typical web browser software application may provide the necessary interface to query and obtain data from the web server circuit. Accordingly, no specialized communication program or protocol is required to display or print information received from the web server circuit.

Communication circuit 50 may be connected to a node on computer network via network port 55. Network port 55 may be any interface suitable to connect a device to a computer network. For example, network port 55 may be an Ethernet port. Accordingly, communication circuit 50 and network port 55 to allow data collection unit 30 to be communicatively connected to a computer network. Due to the limited number of ports and network addresses that may be associated with a rack 10, it is preferable that a data collection unit be associated with each rack 10 rather than each server 15.

Computer network 60 may be a LAN, WAN or other computer network system. One or more terminals 65 may be connected to network 60. Terminal 65 may be a workstation, server, or any similar computer system. Terminal 65 runs a data collection program. The data collection program may be any software suitable to allow a user to view information transmitted from data collection unit 30. As discussed above, data collection units 30 may be connected to network 60. As a result, each data collection unit 30 may transmit the location and status information collected from the servers 15 associated with that data collection unit 30 across network 60. Technicians and other users may view this location and status information via terminals 65. Thus, the location of the servers 15 of data center 5 can be easily determined by the users of network 60. Furthermore, the general condition of servers 15 and racks 10 may be centrally monitored by multiple parties, e.g. users that are connected to network 60. As long as racks 10 are not frequently moved, the locations of servers 15 may be tracked without requiring an on-site inspection of data center 5.

Typically, the data collection program depends on the type of protocol used by the communication circuit 50. For example, if the communication circuit 50 is a web server circuit then the data collection program may be a graphical web browser software application suitable to locate and view web pages. In this case, the location and status information for servers 15 is preferably contained on a web site that the users of terminals 65 may access via web browser software. Preferably, network 60 is closed or secure such that the web site may only be accessed by selected terminals 65 or users.

In addition to directly viewing the location and status information from a data collection unit 30, users may access a secondary data collection program 70 to view summarized data from several racks 10 and servers 15. For small data centers, a user may check or query each server 15 sequentially. However, this may impractical for large data centers. Accordingly, secondary data collection program 70 may provide a consolidated overview of the entire data center. Secondary data collection program 70 may maintain or access a table that contains the rack identification number of each rack 10, the server identification number of the servers 15 contained in that rack 10 for the entire data center, and the physical location of the rack 10. Secondary data collection program 70 may obtain the status and location information from the data collection unit 30. For example, secondary data collection program 70 may query the communication circuits 50 to obtain the information. The secondary data collection program 70 may then present this information to the user. Users of terminals or workstations 65 may access secondary data collection program 70 over network 60. Secondary data collection program 70 is preferably a web based program utilizing HTML or a similar web protocol. As a result, the program 70 may run on any compatible web server without requiring specialized hardware or software.

In addition to responding to queries from users, data collection unit 30 may transmit messages or alerts to agents such as users or software applications. The message protocol would depend on the type of protocol or protocols utilized by communication circuit 50, the type of message, and the agent that will receive the message. For example, data collection unit 30 may send SMTP messages to users. Accordingly, data collection unit 30 may broadcast status or location updates, send alert messages in the event of a failure, and provide similar notification services. For example, if a server 15 is relocated to a different rack 10, a data collection unit 30 may transmit a notification email to a selected user. As another example, if a server 15 experiences a failure, an alert message may be sent to a user. Data collection unit 30 may also transmit notifications to a common gateway interface (CGI) application operative with a central database that may update the location and status information for a server 15 or rack 10 automatically without human intervention. For example, data collection unit 30 may send location and status updates to the secondary data collection program 70 or similar software application. Accordingly, the transmission of messages, such as email notifications, may be coordinated between multiple data control units 30 by the software application.

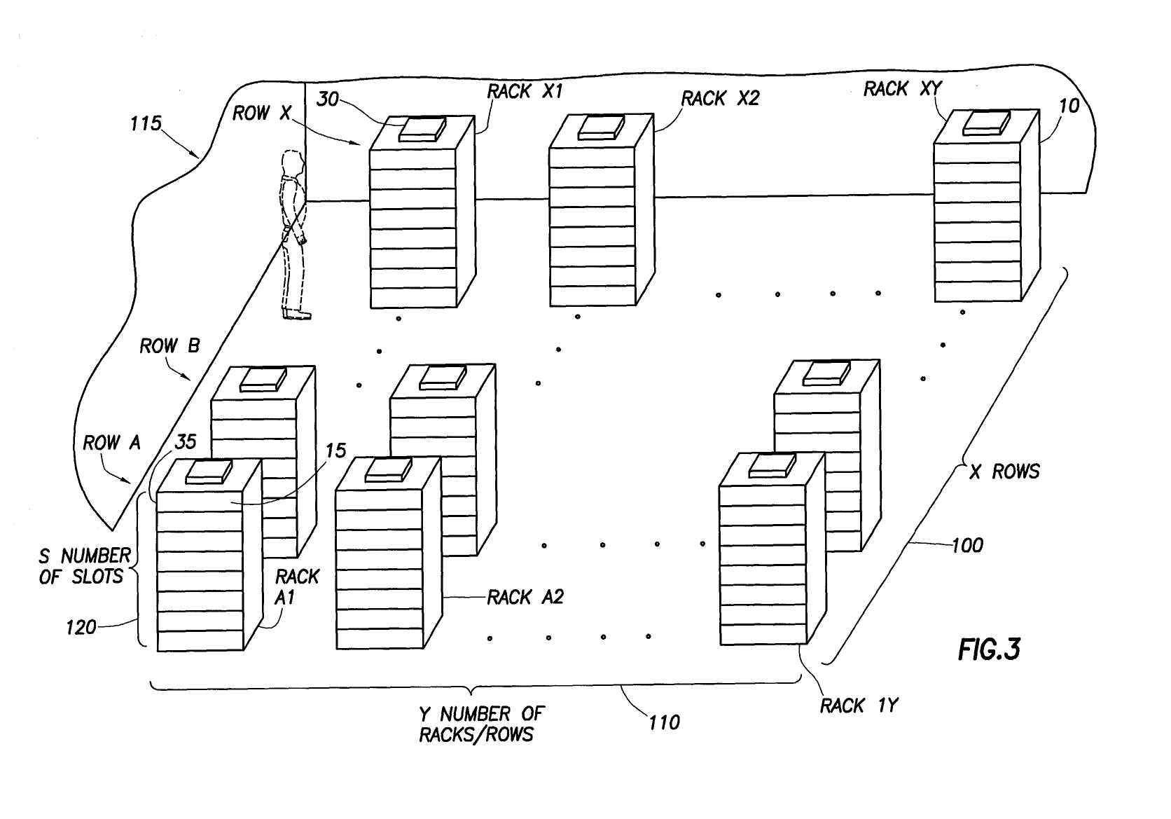

FIG. 3 shows a data center 115 that contains x rows of racks 10, as indicated at 100. In each row, there are y number of racks 10, as indicated at 110. For example, “Row A” corresponds to the first row in data center 145, “Row B, corresponds to the second row, and so forth. Similarly, “Rack A1” is the first rack 10 in Row A, “Rack A2” is the second rack 10 in row A, and so forth. Each rack 10 contains s number of slots 35, as indicated at 120. Becase each slot may contain a server 15, a fully loaded rack 10, will contain s number of servers 15. For the purposes of discussion, there are n number of servers in data center 115. In the example shown in FIG. 3, each rack 10 is associated with a data collection unit 30. There are a total of d number of data collection units 30 in data center 115. Each rack 10 contains r number of rack sensors 45 (shown in FIG. 1). Each server 15 contains m number of server sensors 90 (shown in FIG. 1).

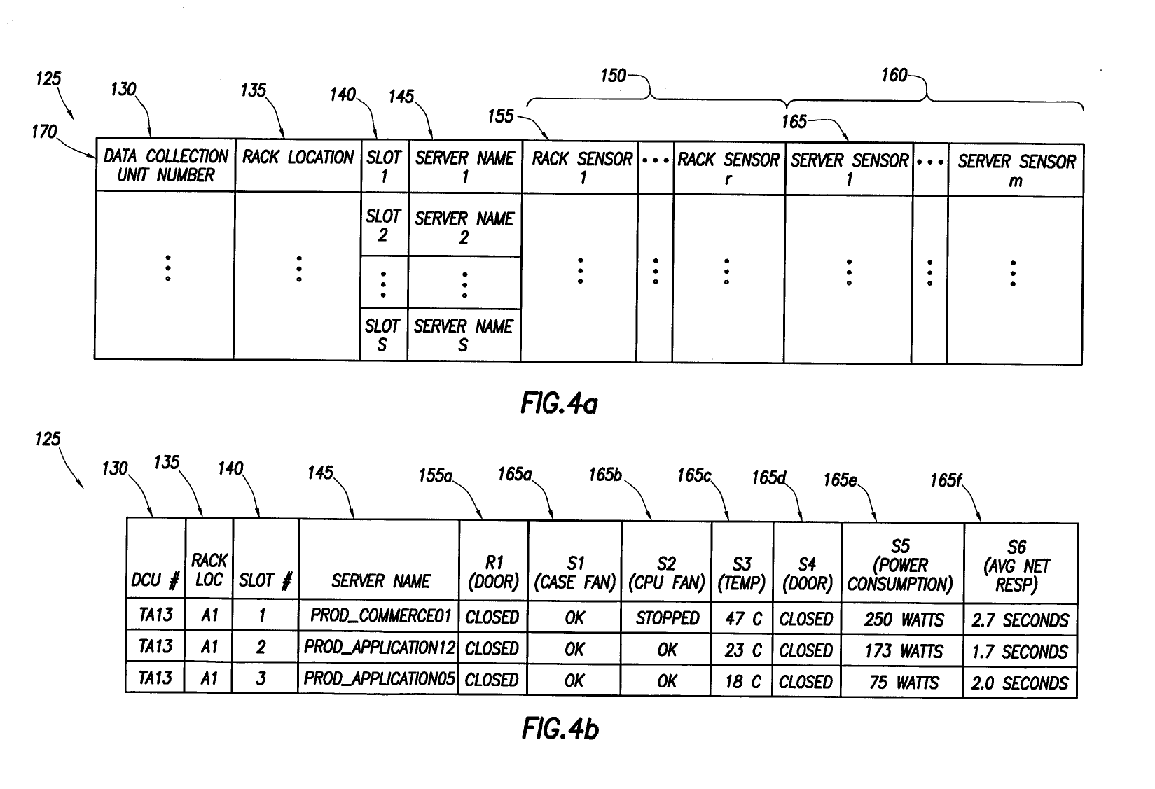

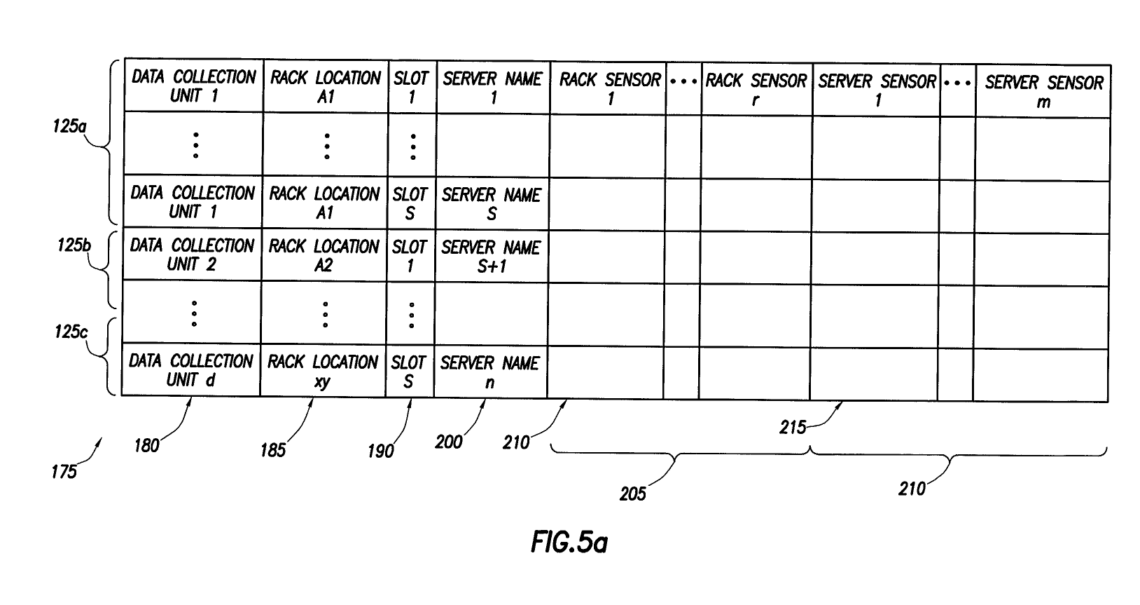

FIGS. 4a and 5a show examples of the tables that may be displayed or maintained by data collection unit 30 and secondary data collection program 70. Table 125, shown in FIG. 4a, is an embodiment of the core display that may be generated by data collection unit 30. Table 125 is preferably associated with a single data collection unit 30 and displays the information collected by that unit 30. Accordingly, data collection unit 30 displays table 125 when queried by a user. The format of table 125 depends on the communication format utilized by data collection unit 30. For example, if data collection unit 30 comprises a web server circuit, then table 125 may be displayed as a web page. Table 125 is preferably a graphical display. The entries of table 125 may be displayed in different colors to communicate varying degrees of importance of the information displayed. For instance, an entry may be displayed in red to communicate a serious problem, in orange for a less severe problem, in yellow for a possible problem, and green for a normal status, among other examples.

Table 125 contains one or more rows 170, depending on the configuration of data center 115. Because table 125 is typically associated with a single data collection unit 30, the number of rows 170 depends on the number of slots 35 or servers 15 in rack 10. The first column 130 contains the data collection unit number, the unique identification number associated with the data collection unit 30. The second column 135 contains the rack location information for the data collection unit. For example, referring to FIG. 3, the rack location information may be “Rack A9” to designate the ninth rack 10 in the first row, “Row A,” of data center 115. Column 140 corresponds to the slot number, from 1 to s. Alternatively, an entry 170 may be displayed only for those slots 35 that contain a server 15. Column 145 corresponds to the server name or label. Alternatively, this column may contain the unique hardware addresses or identification numbers associated with the servers 15. Section 150 contains information collected from racks servers 45. Each column 155 is associated with a type of rack sensor 45 present in one or more racks 10, e.g. rack power supply sensor, and displays the information collected from the rack sensors 45. Section 160 contains information collected from server sensors 90. Each column 165 is associated with a type of server sensor 90 contained in one ore more servers 15, e.g. a temperature sensor, and displays information collected from the server sensor 90. The table shown in FIG. 4a is an example of the data that may be displayed by data collection unit 30. For example, table 125 may contain less information or may be divided into two or more tables. Alternatively, table 125 may contain more information and information from other sources. For example, table 125 may contain data from sensors other than server sensors or rack sensors, instructions, hyperlinks, and other types of information.

FIG. 4b shows an example of table 125. As shown in column 130, the table 125 is associated with data collection unit “TA13.” As shown in column 135, data collection unit “TA13” is located in “Rack A1.” In this example, Rack A1 contains three servers 15. Column 155a contains the information collected from “sensor R1,” a rack door sensor. Columns 165a through 165f contain information from the server sensors S1 through S6. In this example, sensor S1 is a server case fan sensor, sensor S2 is a server CPU fan sensor, sensor S3 is a server temperature sensor, sensor S4 is a server door sensor, sensor S5 is a power consumption sensor, and S6 is a sensor that measures the average network response time. As discussed above, table 125 allows a user to quickly determine the status of all the servers 15 in the rack 10 associated with the data collection unit 30. As a result, a user can readily identify potential problems. For example, in FIG. 4b, the entry under column 165b of table 125 corresponding to server “prod_commerce01” indicates that the server's CPU fan has stopped has stopped. As discussed above, this particular entry may be displayed in red because a stopped fan may be considered a serious problem. A technician may then be dispatched to replace the defective fan.

As discussed above, secondary data collection program 70 may display a consolidated view of the status of all or several of the servers in data center 115. FIG. 5a shows table 175, an embodiment of the core display generated by secondary data collection program 70. Generally, table 175 may combine the tables 125 generated by each data collection unit 30. For example, section 125a corresponds to the table for data collection unit 1, section 125b corrsponds to data collection unit 2, and so forth. Table 175 has columns 180, 185, 190, and 200 to identify the data collection unit, rack location, slot number, and server name, respectively. Section 205 contains the status information collected from the rack sensors 45, wherein each column 210 corresponds to a type of rack sensor 45, present in one or more racks 10. Section 210 contains the status information collection from the server sensors 90, wherein each column 215 corresponds to a type of server sensor 90 present in one or more server 15. The tables in FIGS. 5a and 5b are examples of the information that may be maintained and displayed by secondary data collection program 70. For example, secondary data collection program 70 may store additional information from sources other than data collection units 30. Alternatively, table 175 may summarize the information collected from the data collection units 30. For instance, table 175 may only display those entries necessary to report problems or possible problems. FIG. 5b shows an example of a table 175 generated by the secondary data collection program 70. FIG. 5b shows that the tables 125 from several data collection units 30 may be displayed. In this example, table 175 shows information from data collection units “TA13” in section 125a, “YX33” in section 125b, “CZ82” in section 125c, “UY 58” in section 125d, and “XO26” in section 125e.

Data from each data collection unit 30 may also be collected from a sensor data storage program 75. Sensor data storage program 75 stores the location and sensor data in one or more sensor data storage devices 80. Sensor data storage device 80 may be any non-volatile computer system storage device (e.g. SCSI, ATA, IDE, etc.). Multiple sensor data storage devices 80 may be used and these devices 80 may be configured in any suitable storage network, such as a RAID network, for example. Users may access the sensor data stored in data storage device 80 to determine the performance or status for servers 15 over a period of time.

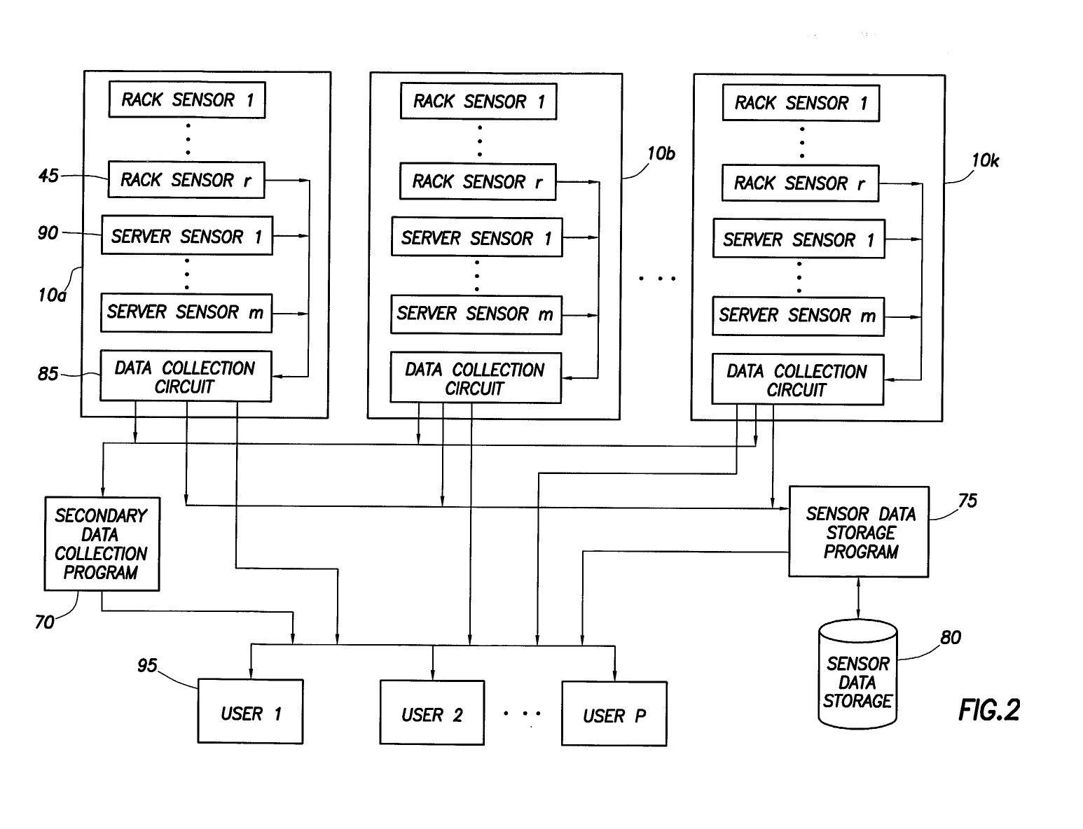

FIG. 2 shows a conceptual block diagram of how the server location and status information is distributed from the sensors through the computer network. In the example shown in FIG. 2, the data center contains k number of racks 10. As discussed above, each rack has two major types of sensors: sensors at the rack level, rack sensors 45, and sensors at the server level, server sensors 90. FIG. 2 depicts one rack sensor 45 per rack 10, but it should be understood that each rack 10 may have one or more rack sensors 45 depending on the requirements for redundancy or monitoring functionality. For the example shown in FIG. 2, each rack contains m number of server sensors 90. In each rack 10, the data collection circuit 85 collects data from the rack sensors 45 and the server sensors 90. As discussed above, the data collection circuit 85 may be a hardware only circuit or a combination of software and hardware.

The data collected by the data collection circuit 85 may be directly sent to one or more users 95. For example, users 95 may access the data over network 60 via a web browser or other software application. The users essentially query each rack 10 via the communication circuit 50 to obtain the status information of the attached servers 15. The data collected by the data collection circuits 85 may also be sent to secondary data collection program 70. As discussed above, the secondary data collection program 70 is a software application that processes the information transmitted by data collection circuits 85. For example, the secondary data collection program 70 may summarize or provide an analysis of the location and status information from several racks 10 and servers 15 to provide a combined or overall view of server performance in the data center 10. Users 95 may also access secondary data collection program via network 60. The user may use a web browser or other software application to view the data processed by secondary data collection program 70.

The data collected by each data collection circuit 85 may also be sent to sensor data storage program 75. Sensor data storage program 75 stores this data in one or more sensor data storage devices 80. Sensor data storage program 75 may store this data according to a predetermined schedule or guideline. If a user 95 wants to determine the status history for a server 15 or rack 10, the user 95 may access the sensor data storage program 75. For example, the user may need to determine the performance or status for a selected group of servers over the course of a selected period of time. The sensor data storage program 75 retrieves the selected data from the appropriate storage device 80 and transmits this information to the user 95. The user may access the sensor data storage program 75 via network 60. The user may use a web browser or other software application to view the data processed by sensor data storage program 75. Sensor data storage program 75 and secondary data collection program 70 may be presented to a user as a single software application.

The system and method of the present disclosure allow multiple users to access status and location information for a data center. These users may access the status and location information from the data collection units over a network. Furthermore, software applications that are suitable for locating and displaying web pages may be used to query the web server circuits. The use of the data collection circuits allows technicians to locate servers without manually maintaining records of the physical locations of the servers. Because multiple users may monitor the status and location of the servers, technicians are in a better position to respond to and resolve service outages.

Although the disclosed embodiments have been described in detail, it should be understood that various changes, substitutions, and alterations can be made to the embodiments without departing from the spirit and the scope of the invention.

What is claimed is:

1. A computer system, comprising:
a rack operable to contain a server;
a server; and
a data collection unit associated with the rack, wherein the data collection unit is operable to receive data and further comprises a communication circuit.

2. The computer system of claim 1, wherein the communication circuit is operable to communicate according to a network protocol.

3. The computer system of claim 2, wherein the network protocol is HTTP, SMTP, TCP/IP, TCP, IP, ARP, IRC, UDP, IGMP or ICMP.

4. The computer system of claim 1, wherein the communication circuit is a web server circuit.

5. The computer system of claim 1,
wherein the rack further comprises a rack sensor; and
wherein the data collection unit is operable to receive data from the rack sensor.

6. The computer system of claim 1,
wherein the server further comprises a server sensor; and
wherein the data collection unit is operable to receive data from the server sensor.

7. The computer system of claim 1,
wherein the rack further comprises a rack connector; and
wherein the server further comprises a server connector, wherein the rack connector and the server connector are operable to couple.

8. The computer system of claim 7,
wherein the server further comprises a server sensor; and
wherein data from the server sensor may be transmitted to the data collection unit when the rack connector is coupled to the server connector.

9. The computer system of claim 7, wherein information relating to the position of the server within the rack may be transmitted to the data collection unit when the rack connector is coupled to the server connector.

10. The computer system of claim 1, further comprising
a network; and
a workstation coupled to the network, wherein a user of the workstation is able to access data from the data collection unit via the communication circuit.

11. The computer system of claim 10, wherein the data collection unit is operable to allow a user to access the data from the data collection unit with software operable to locate and display a Web page.

12. The computer system of claim 10, further comprising a secondary data collection program operable to receive and display data from several data collection units.

13. The computer system of claim 10, further comprising a sensor data storage device.

14. The computer system of claim 13, further comprising a sensor data storage program operable to
store and retrieve data from the sensor data storage device; and
receive data from the data collection unit.

15. The computer system of claim 1,
wherein the server is associated with a unique identification number; and
wherein the data collection unit is operable to receive the unique identification number from the server.

16. The computer system of claim 15, wherein the unique identification number is a MAC address.

17. The computer system of claim 15, wherein the unique identification number is defined by a RFID tag device.

18. The computer system of claim 1,
wherein the rack is associated with a unique identification number; and
wherein the data collection unit is operable to receive the unique identification number from the rack.

19. The computer system of claim 18, wherein the unique identification number is defined by a RFID tag device.

20. The computer system of claim 1, further comprising a load balancer operable to transmit a request signal to the server, wherein the server will transmit a response signal in response to the request signal if the server is properly functioning.

21. The computer system of claim 20, wherein the data collection unit is operable to receive the request signal and the response signal, such that the data collection unit is operable to detect whether a response signal has been transmitted by the server within a selected amount of time.

22. The computer system of claim 21, wherein the data collection unit is operable to transmit a message to the load balancer if the server has not generated a response signal within the selected amount of time.

23. The computer system of claim 10, wherein the data collection unit is operable to transmit a message to the user.

24. The computer system of claim 12, wherein the data collection unit is operable to transmit a message to the secondary data collection program.

25. The computer system of claim 1, wherein the data collection unit comprises a reader operable to read data from RFID tags.

26. The computer system of claim 25, wherein the server is associated with a RFID tag that contains a unique identification number.

27. The computer system of claim 26, wherein the data collection unit is operable to determine the location of the server within the rack.

28. The computer system of claim 25, wherein the rack is associated with a RFID tag that contains a unique identification number.

29. A data collection unit, comprising
a data collection circuit operable to receive data;
a communication circuit; and
a port operable to allow the web server circuit to receive a data request and transmit data received from the data collection circuit in response to the data request.

30 The data collection unit of claim 29, wherein the data collection unit is associated with a rack and is operable to receive data from the rack.

31. The data collection unit of claim 30,
wherein the rack comprises a rack sensor; and
wherein the data collection unit is operable to receive data from the rack sensor.

32. The data collection unit of claim 31,
wherein the rack is associated with a unique identification number; and
wherein the data collection unit is operable to receive the unique identification number.

33. The data collection unit of claim 30, wherein the rack comprises the data collection unit.

34. The data collection unit of claim 29, wherein the data collection unit is associated with a server and is operable to receive data from the server.

35. The data collection unit of claim 34,
wherein the server comprises a server sensor; and
wherein the data collection unit is operable to receive data from the server sensor.

36. The data collection unit of claim 34,
wherein the server is associated with a unique address; and
wherein the data collection unit is operable to receive the unique address from the server.

37. The data collection unit of claim 29, further comprising a reader operable to read data from a RFID tag.

38. The data collection unit of claim 29, wherein the communication circuit is operable to communicate according to a network protocol.

39. The data collection unit of claim 38, wherein the network protocol is HTTP, SMTP, TCP/IP, TCP, IP, ARP, IRC, UDP, IGMP or ICMP.

40. The data collection unit of claim 29, wherein the communication circuit is a web server circuit.

41. A method for collecting and displaying server status information for a computer system comprising a server comprising a server sensor, a data collection unit associated with the server and further comprising a communication circuit, wherein the data collection unit is operable to retrieve data from the server sensor and transmit data via the communication circuit, comprising:
receiving data from the server sensor; and
transmitting the server sensor data to an agent.

42. The method of claim 41, wherein the computer system further comprises a network.

43. The method of claim 42, wherein the agent is a workstation coupled to the computer network.

44. The method of claim 43, wherein the workstation is operable to query the data collection unit to request data from the data collection unit.

45. The method of claim 44, further comprising
querying the data collection unit.

46. The method of claim 41, wherein the computer system further comprises a rack operable to contain a server, wherein the data collection unit is associated with the rack and each server contained in the rack.

47. The method of claim 46, wherein the rack further comprises a rack sensor.

48. The method of claim 47, further comprising:
receiving the data from the rack sensor; and
transmitting the rack sensor data to an agent.

49. The method of claim 41, wherein the server is associated with a unique server identification number and the data collection unit is operable to receive the unique server identification number, further comprising
receiving the unique server identification number; and
transmitting the unique server identification number to an agent.

50. The method of claim 49,
wherein the computer system further comprises a network and
wherein the agent is a workstation coupled to the computer network.

51. The method of claim 49 wherein the agent is a software application operable to display data collected from the data collection unit.

52. The method of claim 49,
wherein the unique server identification number is defined by a RFID tag that is associated with the server; and
the data collection unit further comprises a reader that is operable to read data from the RFID tag.

53. The method of claim 41, wherein the server is associated with a unique rack identification number and the data collection unit is operable to receive the unique rack identification number, further comprising
receiving the unique rack identification number; and
transmitting the unique rack identification number to an agent.

54. The method of claim 53,
wherein the computer system further comprises a network and
wherein the agent is a workstation coupled to the computer network.

55. The method of claim 53 wherein the agent is a software application operable to display data collected from the data collection unit.

56. The method of claim 53,
wherein the unique rack identification number is defined by a RFID tag that is associated with the rack; and
the data collection unit further comprises a reader that is operable to read data from the RFID tag.

57. The method of claim 41, wherein the computer system further comprises a storage device.

58. The method of claim 57, further comprising storing the data collected from the data collection unit in the storage device.

59. The method of claim 41 wherein the agent is a software application operable to display data collected from the data collection unit.

60. The method of claim 41 wherein the computer system further comprises a load bearer operable to transmit a request signal to the server, wherein the server will transmit a response signal in response to request signal if the server is properly functioning.

61. The method of claim 60, wherein the data collection unit is operable to receive the request signal and the response signal, such that the data collection unit is operable to detect whether a response signal has been transmitted by the server within a selected amount of time.

62. The method of claim 61, further comprising
determining whether the response signal has been transmitted by the server within the selected amount of time; and
sending a message to the load bearer if the response signal has not been transmitted by the server within the selected amount of time.
